(19) United States
(12) Patent Application Publication
(10) Pub. No.: US 2007/0039483 A1
(43) Pub. Date: Feb. 22, 2007

(54) DOUBLE-SIDED FRY PAN

(76) Inventor: Se Chul KIM, Seoul (KR)

Correspondence Address: JHK LAW, P.O. BOX 1078, LA CANADA, CA, 91012-1078, US

(21) Appl. No.: 11/161,799

(22) Filed: Aug. 17, 2005

(51) Int. Cl. A47J 37/10

(52) U.S. Cl. 99/422

(57) ABSTRACT

Disclosed herein is a double-sided fry pan, and more particularly, to a double-sided fry pan having packing members disposed at the contact surfaces of an upper pan and a lower pan respectively, so that abrasion of the packing member is reduced, thereby increasing its life span and durability while maintaining a packing function over an extended period of time as well as decreasing the noise generated when the upper pan and the lower pan are contacted to each other. Therefore, A double-sided fry pan according to the present, comprises: an upper pan and a lower pan pivotally coupled to each other by means of a hinge, the upper pan and the lower pan each having a hollow groove formed on the contact surface thereof; and a packing member fittingly coupled into the hollow grooves of the upper pan and the lower pan, respectively, in such a fashion that a part of the packing member is protruded from the contact surface.

### BACKGROUND OF THE INVENTION

1. Field of the Invention

The present invention relates to a double-sided fry pan, and more particularly, to a double-sided fry pan having packing members disposed at the contact surfaces of an upper pan and a lower pan respectively, so that abrasion of the packing member is reduced, thereby increasing its life span and durability while maintaining a packing function over an extended period of time as well as decreasing the noise generated when the upper and lower pans are in contact with each other.

2. Background of the Related Art

A double-sided fry pan 1 configured by combining two fry pans is one of kitchen appliances. This fry pan consists of an upper pan 2 and a lower pan 3 which are coupled at one side thereof to each other by means of hinges 4 and are respectively provided with a grip 5 at the other side thereof, as shown in FIG. 1.

Accordingly, the upper pan and the lower pan 2, 3 are closed each other when cooking.

Further, as shown in FIG. 2 as U.S. Pat. No. 6,619,192 B2, in order to prevent odor or oil from leaking to the outside through a gap between the upper pan 2 and the lower pan 3, the lower pan 3 includes a groove 3a which is formed on the contact surface thereof and the packing member 3b which is fit into the groove 3a. Additionally, the upper pan 2 includes a projection 2a which is formed on the contact surface thereof so as to be fit into the groove 3a and be in close contact with the packing member 3b.

However, there are several disadvantages in that if the upper pan 2 and the lower pan 3 are opened and closed repeatedly, the projection 2a made of metal is repeatedly in close contact with the packing member 3b made of rubber or silicone, so that abrasion of the packing member 3b is increased, thereby decreasing its life span and durability, leading to a failure to perform an intrinsic function of the packing member 3b.

In addition, in the process where the projection 2a of the upper pan 2 is fit into the groove 3a of the lower pan 3, there is an additional shortcoming which noise is generated due to the friction between both contact surfaces of pan.

### SUMMARY OF THE INVENTION

Accordingly, the present invention has been made in view of the above-mentioned problems, and it is an object of the present invention to provide a double-sided fry pan having packing members disposed at the contact surfaces of an upper pan and a lower pan, respectively, so that abrasion of the packing member is reduced, thereby increasing its life span and durability while maintaining a packing function over an extended period of time as well as decreasing the noise generated when the upper pan and the lower pan are in close contact with each other.

To achieve the above objects, according to the present invention, there is provided a double-sided fry pan comprising: an upper pan and a lower pan pivotally coupled to each other by means of a hinge, the upper pan and the lower pan each having a hollow groove formed on the contact surface thereof; and a packing member fittingly coupled into the hollow grooves of the upper pan and the lower pan, respectively, in such a fashion that a part of the packing member is protruded from the contact surface.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of the conventional double-sided fry pan;

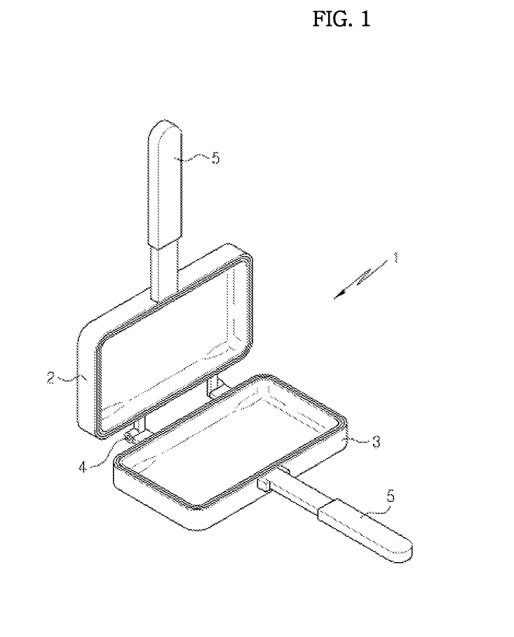

FIG. 2 is a partial cross-sectional view showing a state where the double-sided fry pan is closed in FIG. 1;

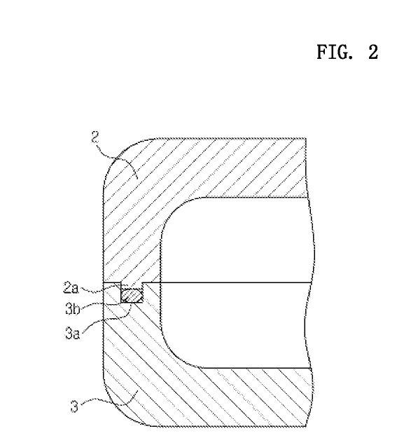

FIG. 3 is a perspective view of a double-sided fry pan according to the present invention; and

FIG. 4 is a cross-sectional view showing a state where packing members of an upper pan and a lower pan are dissembled in the double-sided fry pan according to the present invention.

### DETAILED DESCRIPTION OF THE PREFERRED EMBODIMENT

Reference will now be made in detail to the preferred embodiments of the present invention, examples of which are illustrated in the accompanying drawings.

Explanation on the constitutions and operations which are identical to the conventional prior art will be omitted.

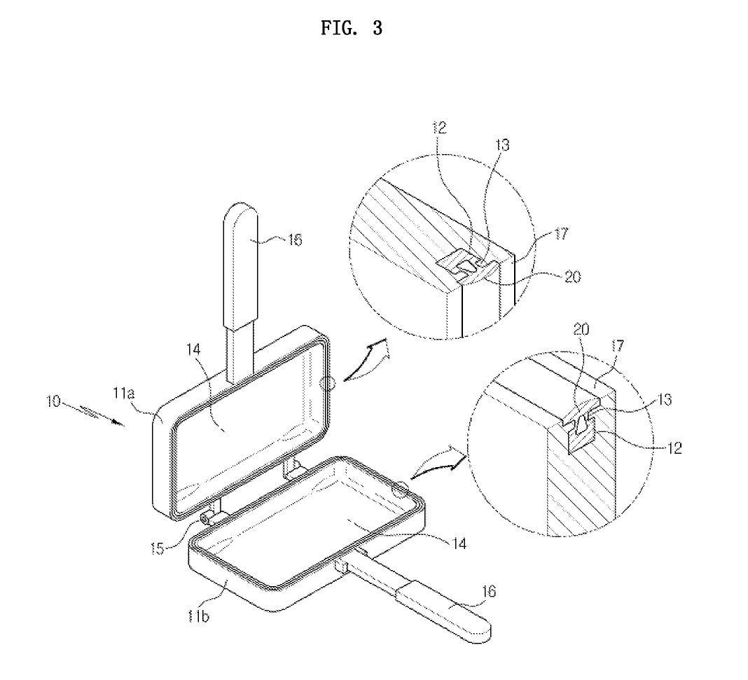

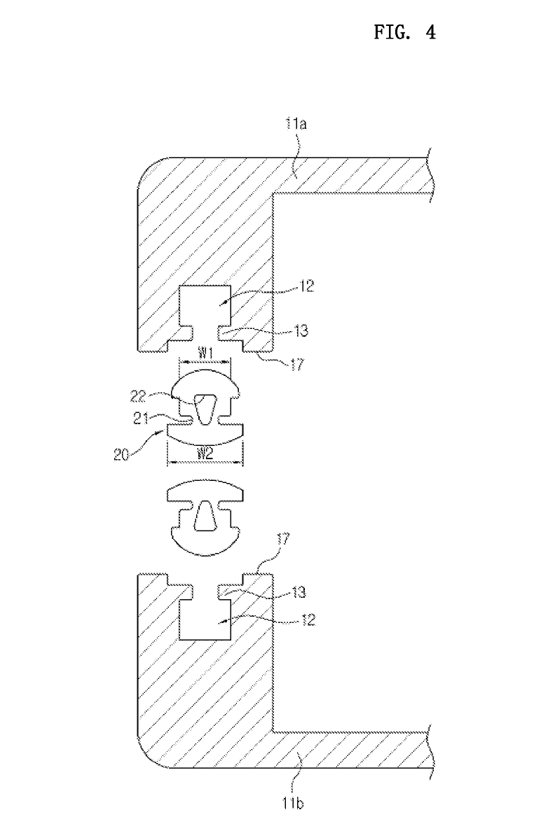

FIG. 3 is a perspective view of a double-sided fry pan according to the present invention, and FIG. 4 is a cross-sectional view showing a state where packing members of an upper pan and a lower pan are dissembled in the double-sided fry pan according to the present invention.

As shown in FIGS. 3 and 4, a double-sided fry pan 10 according to the present invention is configured such that an upper pan 11a and a lower pan 11b are coupled at one side thereof to each other by means of a hinge 15 in such a fashion as to be pivotally rotated.

Each of the upper pan 11a and the lower pan 11b includes a receiving portion 14 formed concavely on the inner side thereof for receiving foods therein, and a grip 16 mounted at one side thereof. At this time, the receiving portions 13 of the upper and lower pans 11a and 11b confront to each other when closing the both pans.

Meanwhile, the grip 16 may further include a locking means (not shown) which is well-known so as to be temporarily locked when the upper and lower pans 11a and 11b are closed each other.

Further, in order to prevent odor or oil from leaking through a gap between the upper pan 11a and the lower pan 11b, when they are closed, each of the upper pan and the lower pan 11a and 11b include a hollow groove 12 formed on the contact surface 17 thereof and a packing member 20 which is fittingly coupled to the hollow groove 12, in such a fashion that a part of the packing member 20 is projected from the contact surface 17.

Moreover, the hollow groove 12 is provided with a pair of retaining protrusions 13 protruding inwardly from both inner surfaces thereof so as to prevent the packing member 20 from escaping therefrom. Each of the packing members of the upper pan and the lower pan is provided with engagement grooves 21 formed at both sides thereof so that the retaining protrusions 13 are fittingly engaged with the engagement grooves 21.

At this time, it is preferred that the width W1 of the upper and lower packing members 20, which are fitted into the hollow groove 12, is made narrower than the width W2 of the upper and lower packing members 20 which are partially protruded outwardly from the contact surface 17. By doing this, the area occupied by the packing member 20 on the contact surface 17 is increased, thereby improving the packing function at the time of closing the upper pan and the lower pan 11a and 11b as well as decreasing the noise generated when the upper pan and the lower pan 11a and 11b are brought into close contact with each other.

Undoubtedly, the inner side width of the hollow groove 12 is made narrower than the outer side width of the hollow groove 12 with respect to the retaining protrusion 13. Thus, the protruding part of the packing member 20, which is protruded from the contact surface 17, is supported safely.

In the meantime, the packing member 20 may include a weight-reducing hole 22 formed therein, so that the elastic force of the packing member 20 can be improved, and the packing member 20 can be smoothly fit into the hollow groove 12. Also the manufacture cost of packing member can be reduced.

As described above, a double-sided fry pan 10 according to the present invention includes hollow grooves 12 formed on the contact surfaces 17 of the upper pan and the lower pan 11a and 11b respectively, and packing members 20 which are fittingly coupled into the hollow grooves 12, in such a fashion that a part of the packing member 20 is protruded from the contact surface 17. When the upper pan and the lower pan are closed, the upper packing member 20 which is fit into the hollow groove 12 of the upper pan 11a is in tight contact with the lower packing member 20 which is fit into the hollow groove 12 of the lower pan 11b, thereby accomplishing a complete packing.

According to the present invention, a double-sided fry pan have packing members disposed at the both contact surfaces of an upper pan and a lower pan, respectively, so that abrasion of the packing member is reduced, thereby increasing its life span and durability while maintaining a packing function over an extended period of time as well as decreasing the noise generated when the upper pan and the lower pan are contacted to each other.

1. A double-sided fry pan comprising:
i) an upper pan and a lower pan pivotally coupled to each other by means of a hinge, the upper pan and the lower pan each having a hollow groove formed on contact surface thereof; and
ii) a packing member fittingly coupled into the hollow grooves of the upper pan and the lower pan, respectively, in such a fashion that a part of the packing member is protruded from the contact surface, wherein
the hollow groove is provided with a pair of retaining protrusions protruding inwardly from both inner surfaces thereof so as to prevent the packing members from escaping therefrom, wherein each of the packing members of the upper pan and the lower pan is provided with engagement grooves formed at both sides thereof so that the retaining protrusions are fittingly engaged with the engagement grooves, wherein
the width of the upper and lower packing members, which are fitted into the hollow groove, is made narrower than the width of the upper and lower packing member which are partially protruded from the contact surface.

2-3. (canceled)
